(19) United States
(12) Patent Application Publication
(10) Pub. No.: US 2024/0422290 A1
(43) Pub. Date: Dec. 19, 2024

(54) AUDIO AND VIDEO CONTROL METHOD WITH INTELLIGENT WIRELESS MICROPHONE TRACKING FUNCTION

(71) Applicant: SHENZHEN AONI ELECTRONIC CO., LTD., Shenzhen (CN)

(72) Inventors: BINGZUO CHEN, Shenzhen (CN); WENLING HUANG, Shenzhen (CN)

(21) Appl. No.: 18/817,509

(22) Filed: Aug. 28, 2024

Related U.S. Application Data
(63) Continuation of application No. PCT/CN2023/099068, filed on Jun. 8, 2023.

(30) Foreign Application Priority Data
Oct. 27, 2022 (CN) 202211324931.8

(51) Int. Cl. H04N 7/15; G10L 25/51; H04N 23/69; H04R 1/40

(52) U.S. Cl. CPC H04N 7/15; G10L 25/51; H04N 23/69; H04R 1/40

(57) ABSTRACT

Disclosed is an audio and video control method with an intelligent wireless microphone tracking function, comprising step S100: an audio and video control system acquiring audio information and video information of the space where a wireless microphone is located, the audio information comprising first audio information and second audio information, and the video information comprising global character image information and local character image information; step S200: analyzing the first audio information to obtain first audio attributes, and matching the distinguished audio attributes with the global character image information; step S300: positioning locations of different personnel according to the second audio information and the local character image information; and step S400: monitoring whether the second audio information of corresponding personnel on all location data is updated, sending the location data and performing global amplification on the local character image information to obtain audio and video monitoring information of the corresponding personnel.

### CROSS-REFERENCE TO RELATED APPLICATIONS

This application is a continuation of co-pending International Patent Application No. PCT/CN2023/099068, filed on Jun. 8, 2023, which claims the priority and benefit of Chinese patent application number 202211324931.8, filed on Oct. 27, 2022 with China National Intellectual Property Administration, the entire contents of which are incorporated herein by reference.

### TECHNICAL FIELD

The present invention relates to the technical field of audio and video control, and particularly relates to an audio and video control method with an intelligent wireless microphone tracking function.

### BACKGROUND

At present, an audio or video conference host system mainly uses a microphone and a loudspeaker as a carrier to transmit a sound signal, where a video conference refers to a meeting for which people at two or more locations communicate in a face-to-face manner through a communication device and a network, and the video conference can be categorized into a point-to-point conference or a multipoint conference according to a number of locations involved therein. Individuals in daily life who have no specific requirements for the security of conversation content, conference quality, and conference scale can use video software for video chats. However, a business video conference held by a government agency, an enterprise, or a nonprofit institution requires a stable and secure network, reliable meeting quality, and a formal meeting environment, and the like, therefore, professional video conference equipment is needed to build a dedicated video conference system that must use television for display, which is also called a teleconference or a video conference.

However, most of the enterprises often organize a plurality of groups of departments to attend a video conference, and each of the groups of departments has many people, who need to discuss with each other during the conference, making it difficult for the microphone in the process of sound pickup to accurately match recorded audio information with an actual speaker. In addition, different spatial environments and fixed positions of persons make it difficult to quickly and efficiently determine the location of each person. Moreover, a camera function of the intelligent microphone cannot accurately capture a video image of a person who is speaking.

### SUMMARY

An objective of the present invention is to provide an audio and video control method with an intelligent wireless microphone tracking function, so as to solve the problems raised in the above background art.

In order to solve the above technical problems, the present invention provides a following technical solution: an audio and video control method with an intelligent wireless microphone tracking function, including the following process:
step S100: an audio and video control system acquiring audio information and video information of a space where a wireless microphone is located, the audio information including first audio information and second audio information, and the video information including global character image information and local character image information;
step S200: analyzing the first audio information according to the audio information in the step S100 to obtain first audio attributes, and distinguishing audios having different attributes; and combining the distinguished audio attributes with the global character image information for analysis, and matching specific character information in the global character image information corresponding to the audios having different attributes in the audio information;
step S300: after completion of the matching, positioning locations of different personnel according to the second audio information and the local character image information, and sending location data of each person to the audio and video control system; and
step S400: after the audio and video control system receiving the location data of all the personnel, monitoring whether the second audio information of the corresponding personnel on all the location data is updated or not; and when the audio and video control system monitoring that the corresponding personnel whose second audio information data has been updated, sending the location data of the personnel, and carrying out global amplification on the local character image information corresponding to the personnel to obtain audio and video monitoring information of the corresponding personnel.

Further, the audio and video control system has a debugging mode and a conference mode; the debugging mode is used to acquire the first audio information and the global character image information, and the conference mode is used to acquire the second audio information and the local character image information;
the debugging mode is used to place a wireless microphone, the wireless microphone is connected to a power supply of an audio and video conference host, the wireless microphone is provided with a power button of a microphone, and shakes up and down, left and right aimlessly to obtain the global character image information and the local character image information; and when the audio and video control system analyzes a specific person, a camera on the wireless microphone will aim at a person, obtain an location address of the person, and send the location address of the person to the audio and video control system; and repeated positioning is performed, the wireless microphone then records the address of each person in the audio and video control system, such that preliminary positioning in the audio and video control system is completed; and
the conference mode is used to have the camera turned to the person corresponding to the location address according to the location address that has been confirmed in the audio and video system, and to amplify the second audio information and the local character image information of the person.

Further, division of the first audio information and the second audio information involves the following process:
step S110: the audio and video control system acquiring audio information in an audio acquisition stage, converting the audio information into digital signals, obtaining a total time interval t0 between adjacent digital signals and a total information length p0 of the digital signals, and calculating an overall vocal fluctuation frequency index of the digital signals, w=p0/t0; where the time interval reflects two situations included in an audio acquisition stage, one is that all the sound are chaotic and irregular, and the other is that sound are regular after the planning is completed; the two situations are distinguished to distinguish the sound change rule applicable in various sound monitoring scenarios; and the fluctuation frequency index represents average changes throughout the audio acquisition stage;
step S120: the audio and video control system traversing from a first digital signal of the audio acquisition stage based on the vocal fluctuation frequency index obtained in the step S110 to obtain a vocal fluctuation frequency between the first digital signal and adjacent digital signals thereof, and subtracting the vocal fluctuation frequency of the first digital signal from the overall vocal fluctuation frequency index to obtain a frequency fluctuation difference; where the frequency fluctuation difference indicates a degree of deviation between the vocal fluctuation frequency and the average fluctuation frequency index in the monitoring scenario over time; and changes of the sound have a critical point for division, and a magnitude of the difference of frequency fluctuation before and after the critical point is not defined herein, such that the laws of sound changes in more scenarios can be accommodated, for example, the frequency fluctuations before the critical point of the sound acquisition is relatively large in some scenarios, while he frequency fluctuations before the critical point of the sound acquisition is relatively small in other scenarios;
step S130: obtaining in sequence a vocal fluctuation frequency between adjacent digital signals in the audio acquisition stage, and marking a transition digital signal; and when a ratio of a frequency fluctuation difference of a preceding adjacent digital signal to a frequency fluctuation difference of a following adjacent digital signal is a negative value, a digital signal corresponding the negative value will be taken as the transition digital signal; and positive and negative frequency fluctuation differences of all the digital signals after transitioning are the same as positive and negative frequency fluctuation differences corresponding to the transition digital signal; and
step S140: by the audio and video control system, partition and identify the audio information before the transition digital signal as the first audio information, and the audio information after the transition digital signal as the second audio information based on the determination rules in the step S130.

Further, the step S200 involves the following process:
step S210: distinguishing the digital signals corresponding to the first audio attributes by frequency similarity, classifying the audio attribute corresponding to the digital signals with the frequency similarity greater than 95% into one category, which is recorded as uⱼ, j={1, 2, . . . k}, where j represents a number of different types of the first audio attributes, and uⱼ represents a j^{th} type of the first audio attributes; and recording a decibel feature of each audio as vⱼₛ, where s is any natural number other than 0, s represents a number of times that the j^{th} type of the first audio attributes after being distinguished appears in the audio acquisition stage, and vⱼₛ represents a decibel feature of an s^{th} occurrence of the j^{th} type of the first audio attributes;

frequency reflects characteristics of sound, and sound frequency of each person is different; a number of persons monitored is identified by frequency, a decibel feature of each person is then analyzed, for a size of the decibel is affected by a distance between a receiving end and a generating end;
step S220: recording different types of the first audio attributes and corresponding decibel features as a set A, and calculating an average decibel difference ratio Gⱼ=Σvⱼₛ′/n of the decibel features corresponding to changes in the j^{th} type of the first audio attributes in the set A over time, respectively, where vⱼₛ′ represents a difference between two adjacent decibel features corresponding to the j^{th} type of the first audio attributes, n represents a number of differences of the decibel features, and n is at least 1; and calculating an overall deviation index Q=(max Gⱼ−min Gⱼ)/ΣGⱼ of different types of the first audio attributes in the set A;
step S230: classifying global images of different characters in the global character image information to obtain a j^{th} type of global character images hⱼ, recording a character proportion of different types of the global character images as a set B, and calculating an average character image proportion difference Dⱼ=Σhⱼ′m corresponding to changes in the j^{th} type of global character images in the set B over time, where hⱼ′ represents a character image proportion difference between two adjacent images in the j^{th} type of global character images, m represents a number of the character image proportion differences, and m is at least 1; and calculating an overall deviation index Z=max Dⱼ−min Dⱼ)/ΣDⱼ of different types of the global character images in the set B;
the overall deviation index reflects a range of decibel levels among all the personnel being monitored and a range of distances reflected in the images, and when the two range are roughly consistent, it indicates a relationship between changes in the decibels and the distances; and
step S240: calculating a deviation index similarity T=Q/Z based on the overall deviation index Q obtained in the step S220 and the overall deviation index Z obtained in the step S230; and when a similarity of the deviation index is greater than a similarity threshold, it indicates that changes in decibel levels of the personnel are associated with movement of personnel location in the global character images, a one-to-one correspondence with a similarity greater than 99% between the average decibel difference ratio in the set A and the average character image proportion difference in the set B is performed to obtain audio attributes corresponding to different characters in the global character image information. When explaining a correlation between the decibel changes and the distances, patterns of decibel change rules of each type of audio attribute and change rules of the global character images are further analyzed, and it can be determined the frequency of each person after matching.

Further, the step S300 involves the following process:
based on the data after one-to-one correspondence in the step S240, the person who first emits sound in the second audio information is taken as a starting person, character proportions of all character images in the local character image information are obtained, the character proportions are sorted from large to small, and location coordinates corresponding to a smallest character proportion image are taken as starting coordinates; and
when any person emits sound in the monitoring process, sector adaptation is performed on the starting coordinates to obtain location coordinates of a second person based on the relationship between the character proportion corresponding to the local character images and the character proportion of the starting person, where the sector adaptation means that the proportion of the personnel emitting sound and the proportion of the character proportion of the starting person is converted into mathematical data by taking the starting coordinates as a center of the sector, and the mathematical data is then used as a radius for estimation in a same direction. Since a plurality of possible locations, such as matrix distribution and circular distribution, are available for distribution of the personnel in a stable state, and when obtaining character images, images of all personnel from one camera position are first obtained, such that a ratio relationship of each person in the images can be determined. Since a position of each person is different, a ratio of character images will be different even if the position of image acquisition remains unchanged, in which case, sector adaptation can improve inclusiveness of the position coordinates.
further, the audio and video control method includes the audio and video control system, which includes a spatial information acquisition module, a spatial information analysis module, a location data acquisition module, and a monitoring data amplification module; and
the spatial information acquisition module is configured to acquire data information of a space where the wireless microphone is located, and transmit the data information to the spatial information analysis module; the spatial information analysis module is configured to analyze the data information from the spatial information acquisition module; the location data acquisition module is configured to determine location information of personnel in the space according to the data information that has been analyzed; and the monitoring data amplification module is configured to, when the spatial information acquisition module obtains new additional data information, globally amplify characters of the new additional data information to obtain audio and video information of corresponding personnel.

Further, the spatial information acquisition module includes an audio information acquisition module and a video information acquisition module; the audio information acquisition module is configured to acquire audio information, which includes the first audio information and the second audio information; and the video information acquisition module is configured to acquire video information, and includes a global character image information acquisition module and a local character image information acquisition module;
the audio information acquisition module includes a digital signal conversion module, a vocal fluctuation frequency index calculation module, a transition digital signal marking module, and an audio information partition module;
the digital signal conversion module is configured to convert the audio information into digital signals, the vocal fluctuation frequency index calculation module is configured to obtain the total time interval t0 between adjacent digital signals and the total information length p0 of the digital signals, and to calculate the overall vocal fluctuation frequency index of the digital signals, w=p0/t0;
the transition digital signal marking module is configured to traverse from the vocal fluctuation frequency between the first digital signal and adjacent digital signals thereof, and subtract the vocal fluctuation frequency of the first digital signal from the overall vocal fluctuation frequency index to obtain a frequency fluctuation difference; and obtain in sequence a vocal fluctuation frequency between adjacent digital signals in the audio acquisition stage, and mark a transition digital signal; and when a ratio of a frequency fluctuation difference of a preceding adjacent digital signal to a frequency fluctuation difference of a following adjacent digital signal is a negative value, a digital signal corresponding the negative value will be taken as the transition digital signal; and positive and negative frequency fluctuation differences of all the digital signals after transitioning are the same as positive and negative frequency fluctuation differences corresponding to the transition digital signal; and
the audio information partition module is configured to partition and identify the audio information before the transition digital signal as the first audio information, and the audio information after the transition digital signal as the second audio information.

Further, the spatial information analysis module includes an audio information analysis module, a video information analysis module, and a character matching module; the audio information analysis module includes an audio attribute classification module, an average decibel difference ratio calculation module, and an audio attribute deviation index calculation module; the video information analysis module includes a global character image classification module, a character image proportion difference calculation module, and a global character image deviation index calculation module; and the character matching module includes a deviation index similarity calculation module and a character audio attribute corresponding module;
the audio attribute classification module is configured to classify the different audio attributes; the average decibel difference ratio calculation module is configured to record decibel features of every audio and record different types of the first audio attributes and corresponding decibel features as a set A, and calculate an average decibel difference ratio of the decibel features corresponding to changes in the j^{th} type of the first audio attributes in the set A over time, respectively; and the audio attribute deviation index calculation module is configured to calculate an overall deviation index of different types of the first audio attributes in the set A;
the global character image classification module is configured to classify character images in the global character image information acquisition module and records proportions of different character images as a set B; the character image proportion difference calculation module is configured to calculate an average character image proportion difference for different types of the global character images in the set B over time; and the global character image deviation index calculation module is configured to calculate an overall deviation index of different types of the global character images; and
the deviation index similarity calculation module is configured to compare numerical similarities between the global character image deviation index calculation module and the audio attribute deviation index calculation module, and when a similarity of the deviation index is greater than a similarity threshold, it indicates that changes in decibel levels of the personnel are associated with movement of personnel location in the global character images; and the character audio attribute corresponding module is configured to perform a one-to-one correspondence with a similarity greater than 99% between the average decibel difference ratio in the set A and the average character image proportion difference in the set B to obtain audio attributes corresponding to different characters in the global character image information.

Further, the location data acquisition module includes a character image proportion sorting module, an initial coordinate setting module, and a sector adaptation module;
the character image proportion sorting module is configured to obtain character proportions of all the character images in the local character image information on the basis that the person who first emits sound in the second audio information is taken as a starting person, and to sort the character proportions from large to small; and the initial coordinate setting module is configured to set location coordinates corresponding to a smallest character proportion image as starting coordinates; and
the sector adaptation module is configured to, when any person emits sound in the monitoring process, perform sector adaptation on the starting coordinates to obtain location coordinates of the second person based on the relationship between the character proportion corresponding to the local character images and the character proportion of the starting person.

Compared with the prior art, the present invention has the following beneficial effects: the present invention solves the problem in intelligent tracking scenarios using wireless microphones, where the large number of people makes it difficult to efficiently and accurately identify the source of a sound and its corresponding individual. As a result, although the sound can be captured during the monitoring, but precise location of the sound cannot be identified. Furthermore, the present invention is also applicable to all environments monitored by the microphones for adjustable positioning, and adopts a method of combining the audio information and the video information to determine the correlation between the spatial sound locations, so as to identify the corresponding relationship between the sound and the individual. The present invention enables the real-time identification of the sound emitted by an individual and the location of the individual in various environments, thereby improving the efficiency of the system in identifying the people; and the present invention increases the inclusiveness of the scene when the location coordinates are located by determining coordinates based on the image proportion.

### BRIEF DESCRIPTION OF DRAWINGS

The accompanying drawings are used for providing further understanding of embodiments in the present invention, and constitute part of the specification, used, together with embodiments of the present invention, to explain the present invention and are not to be construed as limiting the present invention. In the accompanying drawings:

FIG. 1 is a system structural diagram of an audio and video control method with an intelligent wireless microphone tracking function according to the present invention.

FIG. 2 is a step diagram of an audio and video control method with an intelligent wireless microphone tracking function according to the present invention.

FIG. 3 is a block diagram of control principle of an audio and video control system of an audio and video control method with an intelligent wireless microphone tracking function according to the present invention.

FIG. 4 is a block diagram of control principle of a conference microphone of an audio and video control method with an intelligent wireless microphone tracking function according to the present invention.

FIG. 5 is a block diagram of control principle of a camera device host of an audio and video control method with an intelligent wireless microphone tracking function according to the present invention.

### DETAILED DESCRIPTION OF THE EMBODIMENTS

The technical solutions of embodiments of the present invention will be described below clearly and comprehensively in conjunction with accompanying drawings of the embodiments of the present invention. Apparently, the embodiments described are merely some embodiments rather than all embodiments of the present invention. Based on the embodiments of the present invention, all other embodiments acquired by those of ordinary skill in the art without making creative efforts fall within the scope of protection of the present invention.

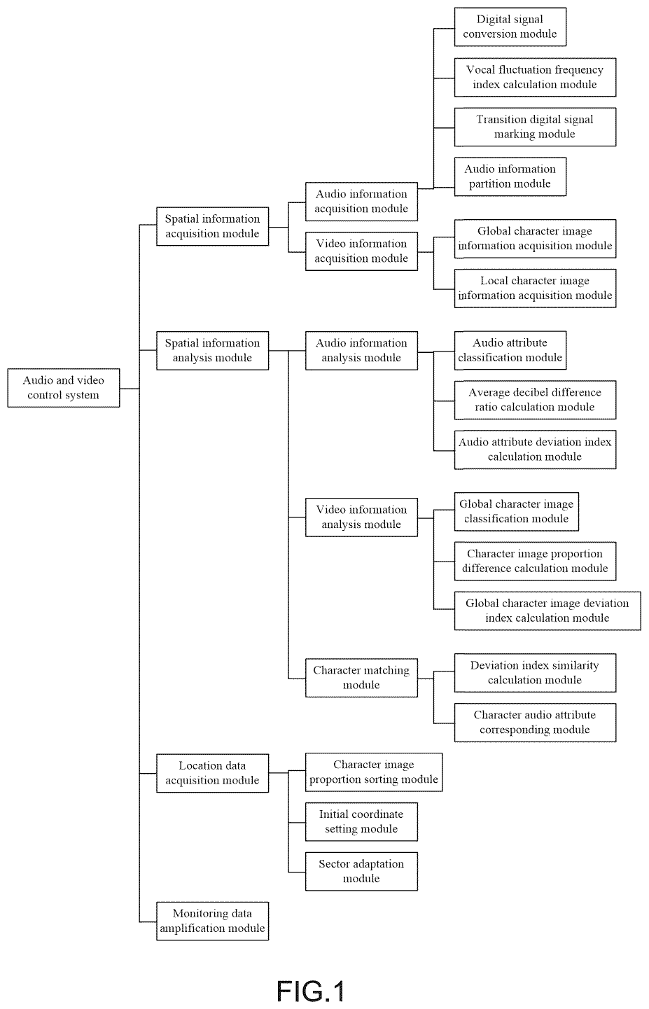

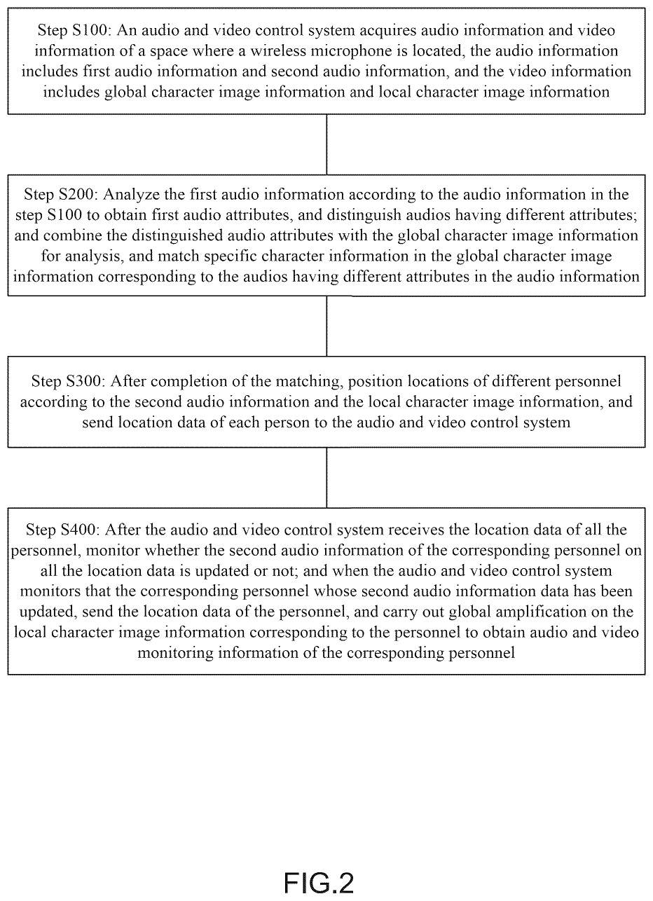

With reference to FIGS. 1-5, the present invention provides an audio and video control method with an intelligent wireless microphone tracking function, including the following specific process:
step S100: an audio and video control system acquires audio information and video information of a space where a wireless microphone is located, the audio information includes first audio information and second audio information, and the video information includes global character image information and local character image information;
step S200: analyzing the first audio information according to the audio information in the step S100 to obtain first audio attributes, and distinguishing audios having different attributes; and combining the distinguished audio attributes with the global character image information for analysis, and matching specific character information in the global character image information corresponding to the audios having different attributes in the audio information;
step S300: after completion of the matching, positioning locations of different personnel according to the second audio information and the local character image information, and sending location data of each person to the audio and video control system; and
step S400: after the audio and video control system receives the location data of all the personnel, monitoring whether the second audio information of the corresponding personnel on all the location data is updated or not; and when the audio and video control system monitors that the corresponding personnel whose second audio information data has been updated, sending the location data of the personnel, and carrying out global amplification on the local character image information corresponding to the personnel to obtain audio and video monitoring information of the corresponding personnel.

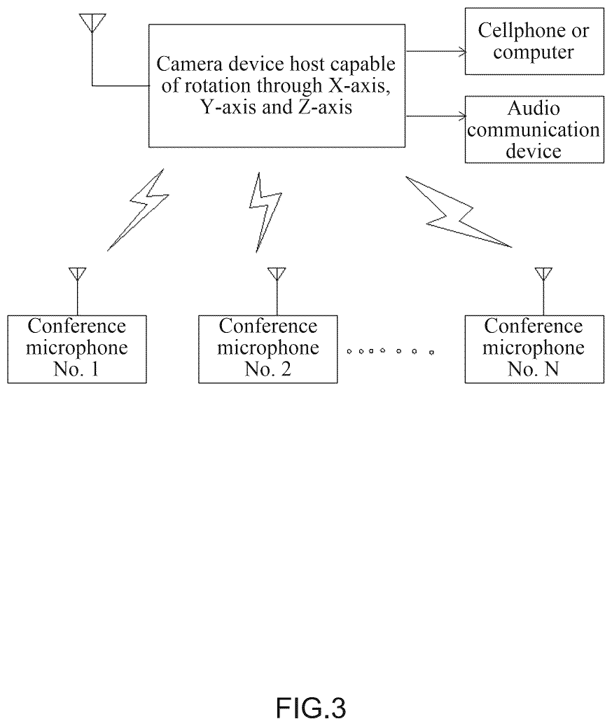

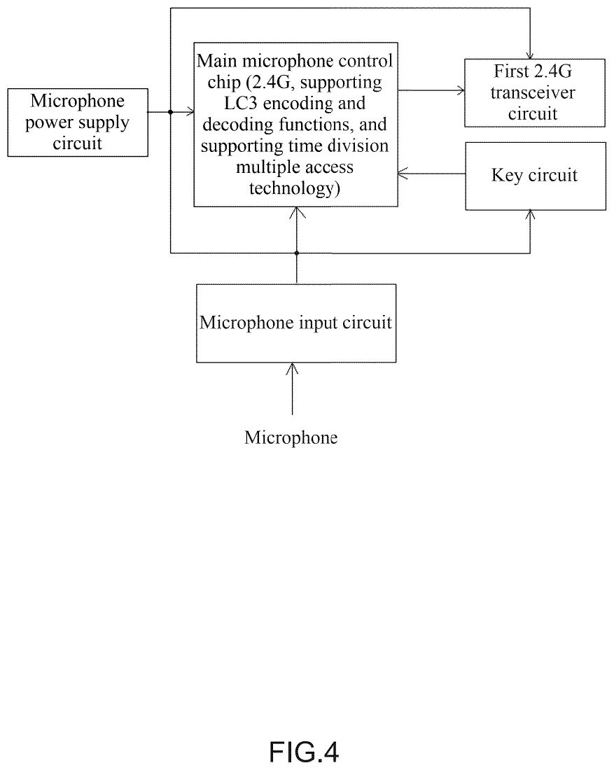

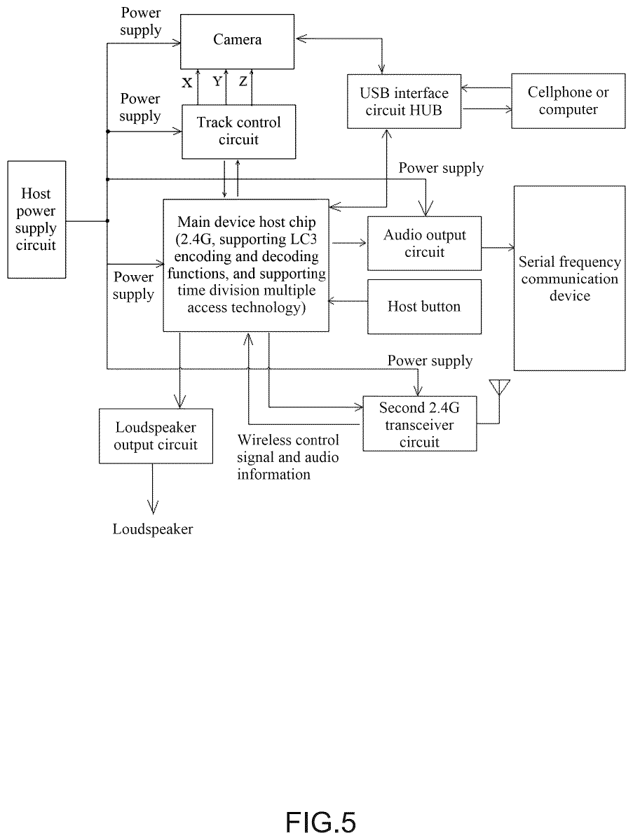

As shown in FIG. 3, the audio and video control system includes a camera device host and a plurality of conference microphones, and each of the conference microphones is connected to the camera device host in a wireless communication manner;
as shown in FIG. 4, each of the conference microphones includes a main microphone control chip, a microphone input circuit, a first 2.4G transceiver circuit, a key circuit, and a microphone power supply circuit, where the microphone input circuit, the first 2.4G transceiver circuit, and the key circuit are respectively connected to the main microphone control chip, and the microphone power supply circuit supplies power to the main microphone control chip, the microphone input circuit, the first 2.4G transceiver circuit, and the key circuit;
as shown in FIG. 5, the camera device host has a camera and a loudspeaker; a circuit structure of the camera device host includes a camera device host chip, an audio output circuit, a host button, a second 2.4G transceiver circuit, a loudspeaker output circuit, a USB interface circuit, a camera, a track control circuit, and a power supply circuit; the camera device host chip is connected to the track control circuit, and the track control circuit is connected to the camera; the camera device host chip is also electrically connected to the USB interface circuit, and the USB interface circuit is also connected to the camera; the camera device host chip is electrically connected to the audio output circuit, and the audio output circuit is connected to an audio communication device; the camera device host chip is electrically connected to the loudspeaker output circuit, and the loudspeaker output circuit is configured to connect to the loudspeaker; and the camera device host chip is further electrically connected to the second 2.4G transceiver circuit;
the main microphone control chip and the camera device host chip are Bluetooth 5.3 LE Audio chips;
the audio and video control system has a debugging mode and a conference mode; the debugging mode is used to acquire the first audio information and the global character image information, and the conference mode is used to acquire the second audio information and the local character image information;
the debugging mode is used to place a wireless microphone, the wireless microphone is connected to a power supply of an audio and video conference host, the wireless microphone is provided with a power button of a microphone, and shakes up and down, left and right aimlessly to obtain the global character image information and the local character image information; and when the audio and video control system analyzes a specific person, a camera on the wireless microphone will aim at a person, obtain an location address of the person, and send the location address of the person to the audio and video control system; and repeated positioning is performed, the wireless microphone then records the address of each person in the audio and video control system, such that preliminary positioning in the audio and video control system is completed; and

the conference mode is used to have the camera turned to the person corresponding to the location address according to the location address that has been confirmed in the audio and video system, and to amplify the second audio information and the local character image information of the person.

As shown in the embodiment, the camera device host has three axes, that is, X-axis, Y-axis and Z-axis, and the camera is driven by the three axes;
after the camera device host is powered on and connected to the camera, tracks of the X-axis, Y-axis and Z-axis perform scanning; and when the camera faces a direction of a conference microphone, the conference microphone sends a command to the camera device host, and the camera device host will then record location data of the tracks of the X-axis, Y-axis and Z-axis corresponding to the conference microphone;
the conference microphone sends out a set of control codes to the camera device host by using a wireless signal, and after receiving the set of control codes, the camera device host controls the camera to turn to the direction of the conference microphone according to the location data of the tracks of the X-axis, Y-axis and Z-axis corresponding to the conference microphone; and

the conference microphone transmits the received audio signal through LE Audio LC3 or LC3+ encoding and decoding technology to form a voice packet, and wirelessly transmits the voice packet to the camera device host by using time division multiple access (TDMA) technology.

Division of the first audio information and the second audio information involves the following process:
step S110: the audio and video control system acquires audio information in an audio acquisition stage, converts the audio information into digital signals, obtains a total time interval t0 between adjacent digital signals and a total information length p0 of the digital signals, and calculates an overall vocal fluctuation frequency index of the digital signals, w=p0/t0; where the time interval reflects two situations included in an audio acquisition stage, one is that all the sound are chaotic and irregular, and the other is that sound are regular after the planning is completed; the two situations are distinguished to distinguish the sound change rule applicable in various sound monitoring scenarios; and the fluctuation frequency index represents average changes throughout the audio acquisition stage;
step S120: the audio and video control system traverses from a first digital signal of the audio acquisition stage based on the vocal fluctuation frequency index obtained in the step S110 to obtain a vocal fluctuation frequency between the first digital signal and adjacent digital signals thereof, and subtracts the vocal fluctuation frequency of the first digital signal from the overall vocal fluctuation frequency index to obtain a frequency fluctuation difference; where the frequency fluctuation difference indicates a degree of deviation between the vocal fluctuation frequency and the average fluctuation frequency index in the monitoring scenario over time; and changes of the sound have a critical point for division, and a magnitude of the difference of frequency fluctuation before and after the critical point is not defined herein, such that the laws of sound changes in more scenarios can be accommodated, for example, the frequency fluctuations before the critical point of the sound acquisition is relatively large in some scenarios, while he frequency fluctuations before the critical point of the sound acquisition is relatively small in other scenarios;
step S130: obtaining in sequence a vocal fluctuation frequency between adjacent digital signals in the audio acquisition stage, and marking a transition digital signal; and when a ratio of a frequency fluctuation difference of a preceding adjacent digital signal to a frequency fluctuation difference of a following adjacent digital signal is a negative value, a digital signal corresponding the negative value will be taken as the transition digital signal; and positive and negative frequency fluctuation differences of all the digital signals after transitioning are the same as positive and negative frequency fluctuation differences corresponding to the transition digital signal; and
step S140: the audio and video control system partitions and identifies the audio information before the transition digital signal as the first audio information, and the audio information after the transition digital signal as the second audio information based on the determination rules in the step S130.

The step S200 involves the following process:
step S210: distinguishing the digital signals corresponding to the first audio attributes by frequency similarity, classifying the audio attribute corresponding to the digital signals with the frequency similarity greater than 95% into one category, which is recorded as uⱼ, j={1, 2, . . . k} where j represents a number of different types of the first audio attributes, and uⱼ represents a j^{th} type of the first audio attributes; and recording a decibel feature of each audio as vⱼₛ, where s is any natural number other than 0, s represents a number of times that the j^{th} type of the first audio attributes after being distinguished appears in the audio acquisition stage, and vⱼₛ represents a decibel feature of an s^{th} occurrence of the j^{th} type of the first audio attributes;
frequency reflects characteristics of sound, and sound frequency of each person is different; a number of persons monitored is identified by frequency, a decibel feature of each person is then analyzed, for a size of the decibel is affected by a distance between a receiving end and a generating end;
step S220: recording different types of the first audio attributes and corresponding decibel features as a set A, and calculating an average decibel difference ratio Gⱼ=Σvⱼₛ′/n of the decibel features corresponding to changes in the j^{th} type of the first audio attributes in the set A over time, respectively, where vⱼₛ′ represents a difference between two adjacent decibel features corresponding to the j^{th} type of the first audio attributes, n represents a number of differences of the decibel features, and n is at least 1; and calculating an overall deviation index Q=(max Gⱼ−min Gⱼ)/ΣGⱼ of different types of the first audio attributes in the set A;
step S230: classifying global images of different characters in the global character image information to obtain a j^{th} type of global character images hⱼ, recording a character proportion of different types of the global character images as a set B, and calculating an average character image proportion difference Dⱼ=Σjₕ′/m corresponding to changes in the j^{th} type of global character images in the set B over time, where hⱼ′ represents a character image proportion difference between two adjacent images in the j^{th} type of global character images, m represents a number of the character image proportion differences, and m is at least 1; and calculating an overall deviation index Z=(max Dⱼ−min Dⱼ)/ΣDⱼ of different types of the global character images in the set B;
the overall deviation index reflects a range of decibel levels among all the personnel being monitored and a range of distances reflected in the images, and when the two range are roughly consistent, it indicates a relationship between changes in the decibels and the distances; and
step S240: calculating a deviation index similarity T=Q/Z based on the overall deviation index Q obtained in the step S220 and the overall deviation index Z obtained in the step S230; and when a similarity of the deviation index is greater than a similarity threshold, it indicates that changes in decibel levels of the personnel are associated with movement of personnel location in the global character images, and a one-to-one correspondence with a similarity greater than 99% between the average decibel difference ratio in the set A and the average character image proportion difference in the set B is performed to obtain audio attributes corresponding to different characters in the global character image information. When explaining a correlation between the decibel changes and the distances, patterns of decibel change rules of each type of audio attribute and change rules of the global character images are further analyzed, and it can be determined the frequency of each person after matching.

For example, three types of the first audio attributes are identified on site, that is, u₁, u₂ and u₃, and each type of the first audio attributes has three decibel features, corresponding to v₁₁, v₁₂, v₁₃, v₂₁, v₂₂, v₂₃, v₃₁, v₃₂, v₃₃, the set A is expressed as {v₁₁=40, v₁₂=60, v₁₃=90, v₂₁=30, v₂₂=70, v₂₃=85, v₃₁=35, v₃₂=60, v₃₃=85}, G₁=Σvⱼₛ′/n=(20+30)/2=25, G₂=27.5, and G₃=20; and then Q=(max G₂−min G₃)/ΣGⱼ=(27.5−20)/72.5≈0.103.
three types of the global character images are available, and the set B will be expressed as {h₁=5%→10%→20%, h₂=6%→15%→20% h₃=4%→13%→18%}, then D₁=Σhⱼ′(5+10)/2=7.5%, D₂=7%, D₃=7%; and Z=(max D₁−min D₂)/ΣDⱼ=(7.5−7)/21.5≈0.023; and
the one-to-one correspondence is to compare the similarities between {v₁₁=40, v₁₂=60, v₁₃=90}, {v₂₁=30, v₂₂=70, v₂₃=85} and {v₃₁=35, v₃₂=60, v₃₃=85} in the set A and {h₁=5%→10%$→20%}, {h₂=6%→15%→20%} and {h₂=4%→13%→18%} in the set B.

The step S300 involves the following process:
based on the data after one-to-one correspondence in the step S240, the person who first emits sound in the second audio information is taken as a starting person, character proportions of all the character images in the local character image information are obtained, the character proportions are sorted from large to small, and location coordinates corresponding to a smallest character proportion image are taken as starting coordinates; and
when any person emits sound in the monitoring process, sector adaptation is performed on the starting coordinates to obtain location coordinates of a second person based on the relationship between the character proportion corresponding to the local character images and the character proportion of the starting person, where the sector adaptation means that the proportion of the personnel emitting sound and the proportion of the character proportion of the starting person is converted into mathematical data by taking the starting coordinates as a center of the sector, and the mathematical data is then used as a radius for estimation in a same direction. Since a plurality of possible locations, such as matrix distribution and circular distribution, are available for distribution of the personnel in a stable state, and when obtaining character images, images of all personnel from one camera position are first obtained, such that a proportion relationship of each person in the images can be determined. Since a position of each person is different, a proportion of character images will be different even if the position of image acquisition remains unchanged, in which case, sector adaptation can improve inclusiveness of the position coordinates.
the audio and video control method includes the audio and video control system, which includes a spatial information acquisition module, a spatial information analysis module, a location data acquisition module, and a monitoring data amplification module; and
the spatial information acquisition module is configured to acquire data information of a space where the wireless microphone is located, and transmit the data information to the spatial information analysis module; the spatial information analysis module is configured to analyze the data information from the spatial information acquisition module; the location data acquisition module is configured to determine location information of personnel in the space according to the data information that has been analyzed; and the monitoring data amplification module is configured to, when the spatial information acquisition module obtains new additional data information, globally amplify characters of the new additional data information to obtain audio and video information of corresponding personnel.

The spatial information acquisition module includes an audio information acquisition module and a video information acquisition module; the audio information acquisition module is configured to acquire audio information, which includes the first audio information and the second audio information; and the video information acquisition module is configured to acquire video information, and includes a global character image information acquisition module and a local character image information acquisition module;
the audio information acquisition module includes a digital signal conversion module, a vocal fluctuation frequency index calculation module, a transition digital signal marking module, and an audio information partition module;
the digital signal conversion module is configured to convert the audio information into digital signals, the vocal fluctuation frequency index calculation module is configured to obtain the total time interval t0 between adjacent digital signals and the total information length p0 of the digital signals, and to calculate the overall vocal fluctuation frequency index of the digital signals, w=p0/t0;
the transition digital signal marking module traverses from the vocal fluctuation frequency between the first digital signal and adjacent digital signals thereof, and subtracting the vocal fluctuation frequency of the first digital signal from the overall vocal fluctuation frequency index to obtain a frequency fluctuation difference; and obtain in sequence a vocal fluctuation frequency between adjacent digital signals in the audio acquisition stage, and mark a transition digital signal; and when a ratio of a frequency fluctuation difference of a preceding adjacent digital signal to a frequency fluctuation difference of a following adjacent digital signal is a negative value, a digital signal corresponding the negative value will be taken as the transition digital signal; and positive and negative frequency fluctuation differences of all the digital signals after transitioning are the same as positive and negative frequency fluctuation differences corresponding to the transition digital signal; and
the audio information partition module is configured to partition and identify the audio information before the transition digital signal as the first audio information, and the audio information after the transition digital signal as the second audio information.
The spatial information analysis module includes an audio information analysis module, a video information analysis module, and a character matching module; the audio information analysis module includes an audio attribute classification module, an average decibel difference ratio calculation module, and an audio attribute deviation index calculation module; the video information analysis module includes a global character image classification module, a character image proportion difference calculation module, and a global character image deviation index calculation module; and the character matching module includes a deviation index similarity calculation module and a character audio attribute corresponding module;
the audio attribute classification module is configured to classify the different audio attributes; the average decibel difference ratio calculation module is configured to record decibel features of every audio and record different types of the first audio attributes and corresponding decibel features as a set A, and calculate an average decibel difference ratio of the decibel features corresponding to changes in the j^{th} type of the first audio attributes in the set A over time, respectively; and the audio attribute deviation index calculation module is configured to calculate an overall deviation index of different types of the first audio attributes in the set A;
the global character image classification module is configured to classify character images in the global character image information acquisition module and records proportions of different character images as a set B; the character image proportion difference calculation module is configured to calculate an average character image proportion difference for different types of the global character images in the set B over time; and the global character image deviation index calculation module is configured to calculate an overall deviation index of different types of the global character images; and
the deviation index similarity calculation module is configured to compare numerical similarities between the global character image deviation index calculation module and the audio attribute deviation index calculation module, and when a similarity of the deviation index is greater than a similarity threshold, it indicates that changes in decibel levels of the personnel are associated with movement of personnel location in the global character images; and the character audio attribute corresponding module is configured to perform a one-to-one correspondence with a similarity greater than 99% between the average decibel difference ratio in the set A and the average character image proportion difference in the set B to obtain audio attributes corresponding to different characters in the global character image information.

The location data acquisition module includes a character image proportion sorting module, an initial coordinate setting module, and a sector adaptation module;
the character image proportion sorting module is configured to obtain character proportions of all the character images in the local character image information on the basis that the person who first emits sound in the second audio information is taken as a starting person, and to sort the character proportions from large to small; and the initial coordinate setting module is configured to set location coordinates corresponding to a smallest character proportion image as starting coordinates; and
the sector adaptation module is configured to, when any person emits sound in the monitoring process, perform sector adaptation on the starting coordinates to obtain location coordinates of the second person based on the relationship between the character proportion corresponding to the local character images and the character proportion of the starting person.

It should be noted that the relation terms, for example, first, second, etc., are used herein merely for distinguishing one entity or operation from another entity or operation but do not necessarily require or imply that there exists any actual relation or sequence between these entities or operations. Furthermore, terms “comprising”, “including” or any other variants thereof are intended to cover the non-exclusive including, thereby making that the process, method, object or apparatus comprising a series of elements comprise not only those elements but also other elements that are not listed explicitly or the inherent elements to the process, method, merchandise or apparatus.

Finally, it should be noted that those skill in the art that the above is only a preferred embodiment of the present invention, and is not intended to limit the present invention. Although the present invention has been described in detail with reference to the above embodiment, for those skilled in the art, it is still apparent that the technical solutions described in the above embodiment may be modified, or some technical features thereof may be equivalently replaced. Any modifications, equivalent substitutions, improvements, and the like within the spirit and principles of the present invention are intended to be included within the scope of protection of the present invention.

What is claimed is:

1. An audio and video control method with an intelligent wireless microphone tracking function, comprising the following process:
step S100: an audio and video control system acquiring audio information and video information of a space where a wireless microphone is located, the audio information comprising first audio information and second audio information, and the video information comprising global character image information and local character image information;
step S200: analyzing the first audio information according to the audio information in the step S100 to obtain first audio attributes, and distinguishing audios having different attributes;
and combining the distinguished audio attributes with the global character image information for analysis, and matching specific character information in the global character image information corresponding to the audios having different attributes in the audio information;
step S300: after completion of the matching, positioning locations of different personnel according to the second audio information and the local character image information, and sending location data of each person to the audio and video control system; and
step S400: after the audio and video control system receiving the location data of all the personnel, monitoring whether the second audio information of the corresponding personnel on all the location data is updated or not; and when the audio and video control system monitoring that the corresponding personnel whose second audio information data has been updated, sending the location data of the personnel, and carrying out global amplification on the local character image information corresponding to the personnel to obtain audio and video monitoring information of the corresponding personnel.

2. The audio and video control method with an intelligent wireless microphone tracking function according to claim 1, wherein the audio and video control system has a debugging mode and a conference mode; the debugging mode is used to acquire the first audio information and the global character image information, and the conference mode is used to acquire the second audio information and the local character image information;
the debugging mode is used to place a wireless microphone, the wireless microphone is connected to a power supply of an audio and video conference host, the wireless microphone is provided with a power button of a microphone, and shakes up and down, left and right aimlessly to obtain the global character image information and the local character image information; and when the audio and video control system analyzes a specific person, a camera on the wireless microphone will aim at a person, obtain an location address of the person, and send the location address of the person to the audio and video control system; and repeated positioning is performed, the wireless microphone then records the address of each person in the audio and video control system, such that preliminary positioning in the audio and video control system is completed; and
the conference mode is used to have the camera turned to the person corresponding to the location address according to the location address that has been confirmed in the audio and video system, and to amplify the second audio information and the local character image information of the person.

3. The audio and video control method with an intelligent wireless microphone tracking function according to claim 1, wherein division of the first audio information and the second audio information involves the following process:
step S110: the audio and video control system acquiring audio information in an audio acquisition stage, converting the audio information into digital signals, obtaining a total time interval t0 between adjacent digital signals and a total information length p0 of the digital signals, and calculating an overall vocal fluctuation frequency index of the digital signals, w=p0/t0;
step S120: the audio and video control system traversing from a first digital signal of the audio acquisition stage based on the vocal fluctuation frequency index obtained in the step S110 to obtain a vocal fluctuation frequency between the first digital signal and adjacent digital signals thereof, and subtracting the vocal fluctuation frequency of the first digital signal from the overall vocal fluctuation frequency index to obtain a frequency fluctuation difference;
step S130: obtaining in sequence a vocal fluctuation frequency between adjacent digital signals in the audio acquisition stage, and marking a transition digital signal, wherein when a ratio of a frequency fluctuation difference of a preceding adjacent digital signal to a frequency fluctuation difference of a following adjacent digital signal is a negative value, a digital signal corresponding the negative value will be taken as the transition digital signal; and positive and negative frequency fluctuation differences of all the digital signals after transitioning are the same as positive and negative frequency fluctuation differences corresponding to the transition digital signal; and
step S140: the audio and video control system partitioning and identifying the audio information before the transition digital signal as the first audio information, and the audio information after the transition digital signal as the second audio information based on the determination rules in the step S130.

4. The audio and video control method with an intelligent wireless microphone tracking function according to claim 2, wherein the step S200 comprises the following process:
step S210: distinguishing the digital signals corresponding to the first audio attributes by frequency similarity, classifying the audio attribute corresponding to the digital signals with the frequency similarity greater than 95% into one category, which is recorded as uⱼ, j={1, 2, . . . k}, wherein j represents a number of different types of the first audio attributes, and uⱼ represents a j^{th} type of the first audio attributes; and recording a decibel feature of each audio as vⱼₛ, wherein s is any natural number other than 0, s represents a number of times that the j^{th} type of the first audio attributes after being distinguished appears in the audio acquisition stage, and vⱼₛ represents a decibel feature of an s^{th} occurrence of the j^{th} type of the first audio attributes;
step S220: recording different types of the first audio attributes and corresponding decibel features as a set A, and calculating an average decibel difference ratio Gⱼ=Σvⱼₛ′/n of the decibel features corresponding to changes in the j^{th} type of the first audio attributes in the set A over time, respectively, wherein vⱼₛ′ represents a difference between two adjacent decibel features corresponding to the j^{th} type of the first audio attributes, n represents a number of differences of the decibel features, and n is at least 1; and calculating an overall deviation index Q=(max G₁−min Gⱼ)/ΣGⱼ of different types of the first audio attributes in the set A;
step S230: classifying global images of different characters in the global character image information to obtain a j^{th} type of global character images hⱼ, recording a character proportion of different types of the global character images as a set B, and calculating an average character image proportion difference Dⱼ=Σhⱼ′/m corresponding to changes in the j^{th} type of global character images in the set B over time, wherein hⱼ′ represents a character image proportion difference between two adjacent images in the j^{th} type of global character images, m represents a number of the character image proportion differences, and m is at least 1; and calculating an overall deviation index Z=(max Dⱼ−min Dⱼ)/ΣDⱼ of different types of the global character images in the set B; and
step S240: calculating a deviation index similarity T=Q/Z based on the overall deviation index Q obtained in the step S220 and the overall deviation index Z obtained in the step S230; and when a similarity of the deviation index is greater than a similarity threshold, it indicates that changes in decibel levels of the personnel are associated with movement of personnel location in the global character images, and a one-to-one correspondence with a similarity greater than 99% between the average decibel difference ratio in the set A and the average character image proportion difference in the set B is performed to obtain audio attributes corresponding to different characters in the global character image information.

5. The audio and video control method with an intelligent wireless microphone tracking function according to claim 3, wherein the step S300 comprises the following process:
based on the data after one-to-one correspondence in the step S240, the person who first emits sound in the second audio information is taken as a starting person, character proportions of all character images in the local character image information are obtained, the character proportions are sorted from large to small, and location coordinates corresponding to a smallest character proportion image are taken as starting coordinates; and
when any person emits sound in a monitoring process, sector adaptation is performed on the starting coordinates to obtain location coordinates of a second person based on the relationship between the character proportion corresponding to the local character images and the character proportion of the starting person, wherein the sector adaptation means that the proportion of the personnel emitting sound and the proportion of the character proportion of the starting person is converted into mathematical data by taking the starting coordinates as a center of the sector, and the mathematical data is then used as a radius for estimation in a same direction.

6. The audio and video control method with an intelligent wireless microphone tracking function according to claim 1, wherein the audio and video control method comprises the audio and video control system, which comprises a spatial information acquisition module, a spatial information analysis module, a location data acquisition module, and a monitoring data amplification module; and
the spatial information acquisition module is configured to acquire data information of a space where the wireless microphone is located, and transmit the data information to the spatial information analysis module; the spatial information analysis module is configured to analyze the data information from the spatial information acquisition module; the location data acquisition module is configured to determine location information of personnel in the space according to the data information that has been analyzed; and the monitoring data amplification module is configured to, when the spatial information acquisition module obtains new additional data information, globally amplify characters of the new additional data information to obtain audio and video information of corresponding personnel.

7. The audio and video control method with an intelligent wireless microphone tracking function according to claim 5, wherein the spatial information acquisition module comprises an audio information acquisition module and a video information acquisition module; the audio information acquisition module is configured to acquire audio information, which comprises the first audio information and the second audio information; and the video information acquisition module is configured to acquire the video information, and comprises the global character image information acquisition module and the local character image information acquisition module;
the audio information acquisition module comprises a digital signal conversion module, a vocal fluctuation frequency index calculation module, a transition digital signal marking module, and an audio information partition module;
the digital signal conversion module is configured to convert the audio information into digital signals, the vocal fluctuation frequency index calculation module is configured to obtain the total time interval t0 between adjacent digital signals and the total information length p0 of the digital signals, and to calculate the overall vocal fluctuation frequency index of the digital signals, w=p0/t0;
the transition digital signal marking module traverses from the vocal fluctuation frequency between the first digital signal and adjacent digital signals thereof, and subtracts the vocal fluctuation frequency of the first digital signal from the overall vocal fluctuation frequency index to obtain a frequency fluctuation difference; and obtain in sequence a vocal fluctuation frequency between adjacent digital signals in the audio acquisition stage, and mark a transition digital signal, wherein when a ratio of a frequency fluctuation difference of a preceding adjacent digital signal to a frequency fluctuation difference of a following adjacent digital signal is a negative value, a digital signal corresponding the negative value will be taken as the transition digital signal; and positive and negative frequency fluctuation differences of all the digital signals after transitioning are the same as positive and negative frequency fluctuation differences corresponding to the transition digital signal; and
the audio information partition module is configured to partition and identify the audio information before the transition digital signal as the first audio information, and the audio information after the transition digital signal as the second audio information.

8. The audio and video control method with an intelligent wireless microphone tracking function according to claim 6, wherein the spatial information analysis module comprises an audio information analysis module, a video information analysis module, and a character matching module; the audio information analysis module comprises an audio attribute classification module, an average decibel difference ratio calculation module, and an audio attribute deviation index calculation module; the video information analysis module comprises a global character image classification module, a character image proportion difference calculation module, and a global character image deviation index calculation module; and the character matching module comprises a deviation index similarity calculation module and a character audio attribute corresponding module;
the audio attribute classification module is configured to classify the different audio attributes; the average decibel difference ratio calculation module is configured to record decibel features of every audio and record different types of the first audio attributes and corresponding decibel features as a set A, and calculate an average decibel difference ratio of the decibel features corresponding to changes in the j^{th} type of the first audio attributes in the set A over time, respectively; and the audio attribute deviation index calculation module is configured to calculate an overall deviation index of different types of the first audio attributes in the set A;
the global character image classification module is configured to classify character images in the global character image information acquisition module and records proportions of different character images as a set B; the character image proportion difference calculation module is configured to calculate an average character image proportion difference for different types of the global character images in the set B over time; and the global character image deviation index calculation module is configured to calculate an overall deviation index of different types of the global character images; and
the deviation index similarity calculation module is configured to compare numerical similarities between the global character image deviation index calculation module and the audio attribute deviation index calculation module, and when a similarity of the deviation index is greater than a similarity threshold, it indicates that changes in decibel levels of the personnel are associated with movement of personnel location in the global character images; and the character audio attribute corresponding module is configured to perform a one-to-one correspondence with a similarity greater than 99% between the average decibel difference ratio in the set A and the average character image proportion difference in the set B to obtain audio attributes corresponding to different characters in the global character image information.

9. The audio and video control method with an intelligent wireless microphone tracking function according to claim 6, wherein the location data acquisition module comprises a character image proportion sorting module, an initial coordinate setting module, and a sector adaptation module;
the character image proportion sorting module is configured to obtain character proportions of all the character images in the local character image information on the basis that the person who first emits sound in the second audio information is taken as a starting person, and to sort the character proportions from large to small; and the initial coordinate setting module is configured to set location coordinates corresponding to a smallest character proportion image as starting coordinates; and
the sector adaptation module is configured to, when any person emits sound in the monitoring process, perform sector adaptation on the starting coordinates to obtain location coordinates of the second person based on the relationship between the character proportion corresponding to the local character images and the character proportion of the starting person.
